(19) United States
(12) Patent Application Publication
(10) Pub. No.: US 2017/0024743 A1
(43) Pub. Date: Jan. 26, 2017

(54) METHOD AND SYSTEM FOR MANAGING PAYMENT OPTIONS

(71) Applicant: Dashlane, Inc., New York, NY (US)

(72) Inventors: Alexis Fogel, Paris (FR); Guillaume Maron, Paris (FR); Charles Kimble, New York, NY (US); Tanguy Le Barzic, Montreuil (FR)

(73) Assignee: Dashlane, Inc., New York, NY (US)

(21) Appl. No.: 15/208,453

(22) Filed: Jul. 12, 2016

Related U.S. Application Data
(60) Provisional application No. 62/196,127, filed on Jul. 23, 2015.

(51) Int. Cl. G06Q 20/40; H04L 29/08; H04L 29/06; G06Q 20/38; G06Q 20/10

(52) U.S. Cl. CPC G06Q 20/4014; G06Q 20/3821; G06Q 20/10; H04L 63/083; H04L 67/02

(57) ABSTRACT

Embodiments of the present disclosure provide methods and system for managing payment options. The methods may include receiving a trigger for updating user information associated with a payment option, the trigger comprising a change in the user information associated with the payment option. Upon receiving the trigger, at least one website associated with the payment option may be determined. A script may be provided to be run on the determined at least one website to update the user information. The generated script may be executed on the at least one website to update the user information.

### BACKGROUND

The United States has one of the highest rates of credit and debit card ownership in the world. Cards, such as American Express™, Visa™, MasterCard™ and Discover™ are aggressively marketed to consumers and businesses across the country. For example, in United Stated people have on average between four and five cards. The cards that Americans carry are also dynamic. Forty percent of those cards change every year, for reasons of expiry, fraud, lost/stolen, etc. In many cases, card changes require the user to manually update account numbers, expiry date, and CVV, with all of the merchants where card information is stored. As a result of this proliferation of bank cards and the frequent changes in card details, it is increasingly challenging for consumers and businesses to keep their card details online current, meaning either and not limited to: having an optimal way to store, retrieve, update and delete card information associated to merchant websites. While MasterCard and Visa provide card updates for some merchants with recurring payments, there is no consumer application to update card information today. Further, the network solutions are not ubiquitous, so generally only large merchants are covered. There is also no way for an issuing bank to allow its customers to take control of the situation and resolve the problem itself.

### BRIEF DESCRIPTION OF THE DRAWINGS

Non-limiting and non-exhaustive examples are described with reference to the following figures. As a note, the same number represents the same element or same type of element in all drawings.

FIG. 1 illustrates an exemplary environment in which methods and systems for managing multiple payment options associated with a user as described herein may be implemented.

FIG. 2 illustrates an exemplary method for managing multiple payment options associated with a user as described herein.

FIG. 3 illustrates another exemplary method for managing multiple payment options associated with a user as described herein.

FIG. 4 illustrates a flow diagram for a method for managing multiple payment options associated with a user as described herein.

FIG. 5 illustrates one example of a suitable operating environment in which one or more of the present examples may be implemented.

### DETAILED DESCRIPTION

Various embodiments are described more fully below with reference to the accompanying drawings, which form a part hereof, and which show specific exemplary embodiments. However, embodiments may be implemented in many different forms and should not be construed as limited to the embodiments set forth herein; rather, these embodiments are provided so that this disclosure will be thorough and complete, and will fully convey the scope of the embodiments to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

Embodiments of the disclosure may provide an application and system for managing payment options for electronic payment systems. For example, an application may be provided on a device. The application may include a list of payment options available to a user. The payment options may include one or more credit cards, one or more debit cards, one or more special purpose cards, and one or more of network-banking services. Each of the payment options may be associated with specific information. For example, each of the payment options may be associated with identification numbers (such as card number and account number), cardholder names, a card verification value (CVV), zip codes, and other relevant card information.

The application may present information for display to the user as to which websites or merchants are storing payment option information. For example, the application may provide, as part of a subscription service, such information so that the user can be aware of which entities are storing the user's card information. To provide the information, the application may keep track, in a secured way, of usage and storage of card information whenever the user employs one or more cards on the websites of merchants.

The application may automatically monitor the stored card information associated with the payment options. For example, the application may monitor for a change in stored card-specific information. Upon determining a change in the stored information associated with a card, for example, the application may automatically identify websites of merchants associated with the card. In addition, the application may automatically trigger a change process to update the card information on the identified websites. Alternatively, the change process may be triggered by receiving user input to update the card information on one more selected websites. Hence, the application may provide a service that allows the user to automatically change their cards on file through one or multiple websites with a single click, without logging into the site individually or personally or going through the change card process for each website directly.

In some examples, the application may start by identifying the web browser used by the user's machine. The application may do so, for example, but not limited to, by identifying the default application on the user's environment to open an HTTP link of HTML files. During the initialization phase, the application may employ the user-agent of the default web browser. Before performing an operation on a specific website, such as a card changing operation, the application may retrieve the cookies associated with this website on the default web browser, and inject them into the background browser used for the card changing operation. Doing so, the application may decrease the chances of the website asking for additional verifications such as—but not limited to—captcha or token sent by email.

In some examples, the application may use additional information to identify for the user the best payment option for a specific website. For that purpose, the application may use the stored purchase history of the user or the knowledge of the previous payment options registered on a website to identify which payment option should be updated on this website. The application may also use detailed information, provided by the payment option issuer—such as a bank for a credit card—to identify the best payment option for a specific website. For example, a bank may provide better or worse travel insurance coverage when an airplane ticket is purchased with one of its issued cards.

The change card process may include executing a script to update the card information on the websites. For example, upon expiry of a credit card, the application may automatically execute a script to remove the expired credit card information saved on the websites. In another example, the application may automatically execute a script to change card information from a first card to a second card on a website.

The script for updating the card information may be generated by a server associated with the application and may include one or more of the following steps: retrieving the list of associated merchant websites for a given card, retrieving the history of associated purchases, accessing the merchant URL, logging in the user automatically using credentials stored in the application, navigating to the page related to the card information update, and updating and submitting the new card information. For example, the application may send the details required for updating the card information to the server. The details may include updated card information, websites to be updated, website domains, login credentials for the websites, etc. The server, using such information, may generate one or more scripts. A separate script may be generated for each update and for each website. Hence, multiple scripts may be executed to update card information associated with a single credit card.

The generated scripts may be automatically executed on the websites to update the card information. The scripts may be executed to log in as the user on the websites and update the card information. The scripts may either be executed directly by the application or indirectly via the server. If executed by the server, the server may forward an outcome of the execution to the application, which in turn may cause it to be displayed to the user. If any additional information is required to update the card information on the websites, the application may prompt the user for the additional information on, e.g., the user's computing device.

In some example, scripts could be run directly from the application, instead of from the server. Running the scripts directly from the application may specifically be needed for merchant websites checking for personalized and consistent geolocation and IP addresses. In addition, in automatic processes, the associated merchant website may be analyzed using semantic analysis instead of scripts, to populate card information.

In some examples, a hybrid solution may be designed based on the previous embodiments, involving both manual scripts and automatic semantic processes to populate card information. For example, an automatic population based on semantic analysis may be triggered first with a fallback on manual scripts or user input.

In some examples, the application may receive a breach alert warning of breached data on a merchant website or at a bank. The application may cause such information to be displayed to a user. The user may then use the application to automatically update any card information associated with the breach.

In some examples, the application may provide a means to delete the card information stored with a merchant website instead of updating or replacing it. This may prove useful in the case the user no longer wants to have the user's card information stored on that merchant website.

Hence, systems and methods disclosed herein provide a technical solution that allows the cards to be automatically replaced at selected sites with the touch of a button (and without having to individually go into those sites and replace the cards). The process may work in a universal way without requiring integration or any partnership with the website on which the card information is being updated. For example, the process may provide techniques to: update all accounts associated with an expired card in one click, change a card on a file immediately on acceptance of upsell/discount promotions for upsell or discount to user to promote a specific card feature, and when the user decides to move to a different credit card for his or her own reasons.

A number of technical advantages are achieved based on system and methods described in the present disclosure. These advantages may include, but are not limited to, the following: the use of the application requires no integration or other action by the merchant/bank with the cards on file, allows the user to select where their card is updated, allows the user to select whether a card is updated or replaced with a different card, provides the user with a list of known places where the card has been used and/or is on file, one-button click to update data on multiple websites, and ability to communicate with the user if any additional information is required (such as a security question, image identification, etc.). The system and methods also provide convenience to the user without the complexity of managing the changes manually for the card information stored on each of the different merchant websites individually.

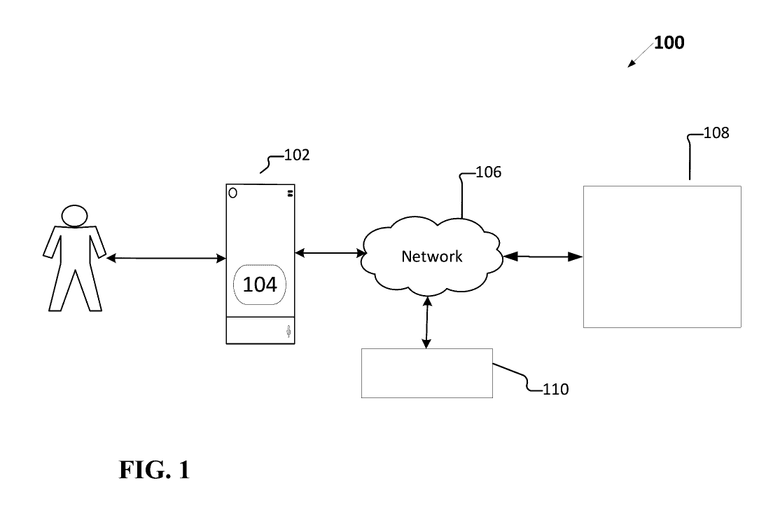

Referring now to the drawings, in which like numerals represent like elements, various embodiments will be described. For example, FIG. 1 illustrates an environment in which methods and systems for managing multiple payment options associated with a user as described herein may be implemented.

Environment 100 may include a processing device 102, an application 104, a network connection 106, a server 108, and one or more web server 110. Processing device 102 may be any device comprising at least one processor and at least one memory/storage. For example, processing device 102 may include devices such as phones, tablets, laptops, watches, desktop computers, servers, etc. Processing device 102 may communicate with server 108 via network 106. Processing device 102 may further communicate with websites associated with merchants or financial institutions via network 106.

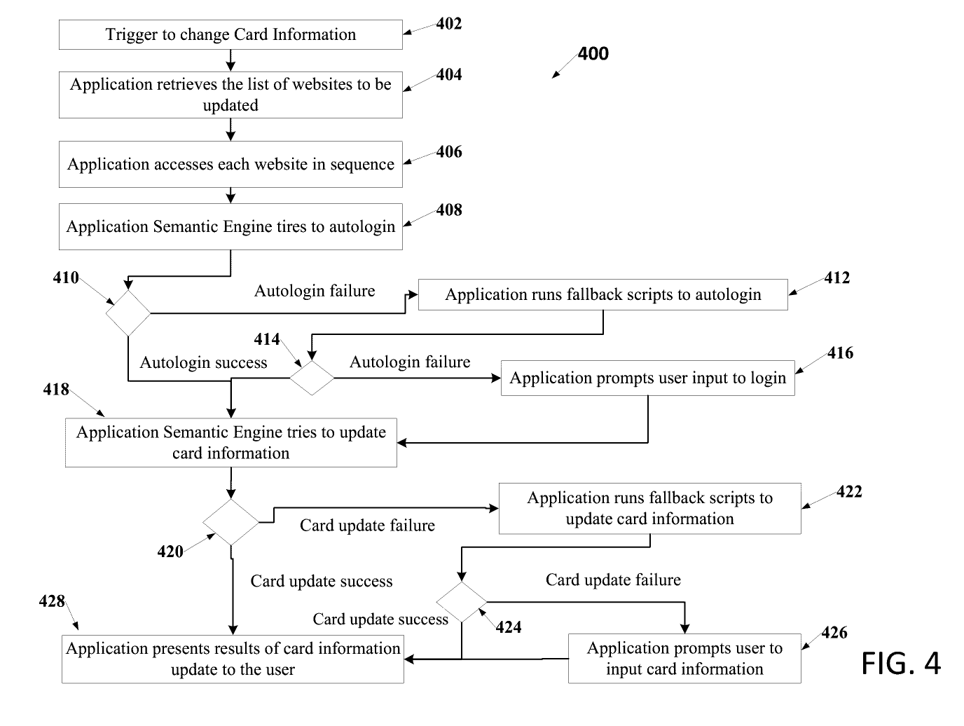

Server 108 may be one or more computing devices, such as such as the computing device illustrated in FIG. 4. In one example, server 108 may a plurality of distributed servers or cloud servers. Network 106 may be any type of network capable of facilitating communications between processing device 102 and server 108. Examples of such networks include, but are not limited to, LANs, WANs, cellular networks, and/or the Internet. Web server 110 may be one or more computing devices, such as such as the computing device illustrated in FIG. 4. In one example, web server 110 may be a plurality of distributed servers or cloud servers. Processing device 102 and server 108 may communicate with web server 110 via network 106 to access merchant websites.

Application 104 may reside on processing device 102. In examples, application 104 may also be partially distributed and stored on server 108. Application 104 may be used by a user to manage one or more payment options available to the user. For example, application 104 may be used to manage one or more cards and card specific information associated with one or more merchants and websites. Application 104 may further provide a user interface to view card details including a listing of cards, expiration date of cards, issuing institution, merchants/websites where the credit card information is saved for payment purposes, etc. The user interface may provide an option to select one of the cards and view in-depth information associated with the selected card. For example, upon selection of a card, the user interface may display details such as: name of issuing institution, name of a card holder, expiry date, merchants where card is listed for payment, etc. In one example, only a thin version of application 104 may reside on processing device 102. The thin version may be launched to extract information stored on server 108.

Application 104 may be associated with one or more user profile. For example, a user profile may be created, which may be stored locally on processing device 102. Application 104 may prompt the user to create a user profile. The user may create login credentials including a user name and a password by inputting information to processing device 102. After creating the login credentials, application 104 may prompt the user to enter payment options associated with the user through the user interface. For example, the application may prompt the user to enter details of credit cards, debit cards, and net-banking services associated with the user. In addition, application 104 may further prompt the user to enter one or more merchants where credit card information of the user is saved. Application 104 may further prompt the user to provide website domains of the websites of the merchants as well as login credentials in those web sites.

In some examples, the details of the cards, merchants, websites associated with merchants, and website domains may automatically be populated by application 104. Application 104 may further provide a list of cards and list of merchants for the user to choose when populating the user profile. For example, application 104 may provide a list of popular credit card providers based on a geographical location of the user. Furthermore, application 104 may provide a list of merchants popular in an area based on the location of the user and purchasing habits. The list of cards and merchants may be presented on the user interface in any suitable manner, such as a drop-down menu or as a slide. Application 104 may store card information entered by the user in an encrypted format either locally at processing device 102 or remotely at server 108.

Application 104 may be triggered by the user to manage one or more payment options. The user may initiate application 104 on processing device 102 to update the user's card information. For example, the user may receive a message that if the user employs the user's second card when shopping at a particular merchant, the user may get double points. The user currently may have the user's first card on file with the merchant and may have made purchases at the merchant while via application 104. The user may select “change card” in the body of the promotional message and, if application 104 is running on that machine, application 104 will automatically change the card on file with the merchant.

In one embodiment, application 104 may prompt the user to initiate application 104. For example, upon detecting a change in card information with one or more cards associated with the user profile, application 104 may send an alert message to the user. The alert message may indicate the user of the change in the card information. Application 104 may receive, for example, a direct notification of new card information from a computer network associated with an issuing institution.

In some examples, application 104, upon initiation, may prompt the user to enter login credentials. The user may provide the login credentials using the user interface. Based on the login credentials, application may already know on what accounts the user has made a purchase (and with which card), and where the user has cards on file (and which ones). Hence, prior to prompting the user, application 104 may check all of their known card-on-file accounts to determine which card they have on file and provide the user the option to change all, some or none of these cards. Application 104 may further identify websites where it knows the user has this card on file, and identify websites where scripts have been developed to automate card replacement. The user may be presented with a prompt to automatically update the card data at those websites where: application 104 may infer or otherwise knows the user has an expired card on file, application 104 has login credentials for the customer (username and password), and application 104 has a script on file to automate payment information updating. The user may have the option to have the card number updated on all of the listed websites, or can select a subset of these websites to automate the card updating process. The user may take action to indicate selected changes should be made by application 104. Using scripts, application 104 may log into each selected website as the user and replace a primary card on file with the updated card information. The user may be notified within the user interface for application 104 and/or via an electronic message when the update is complete.

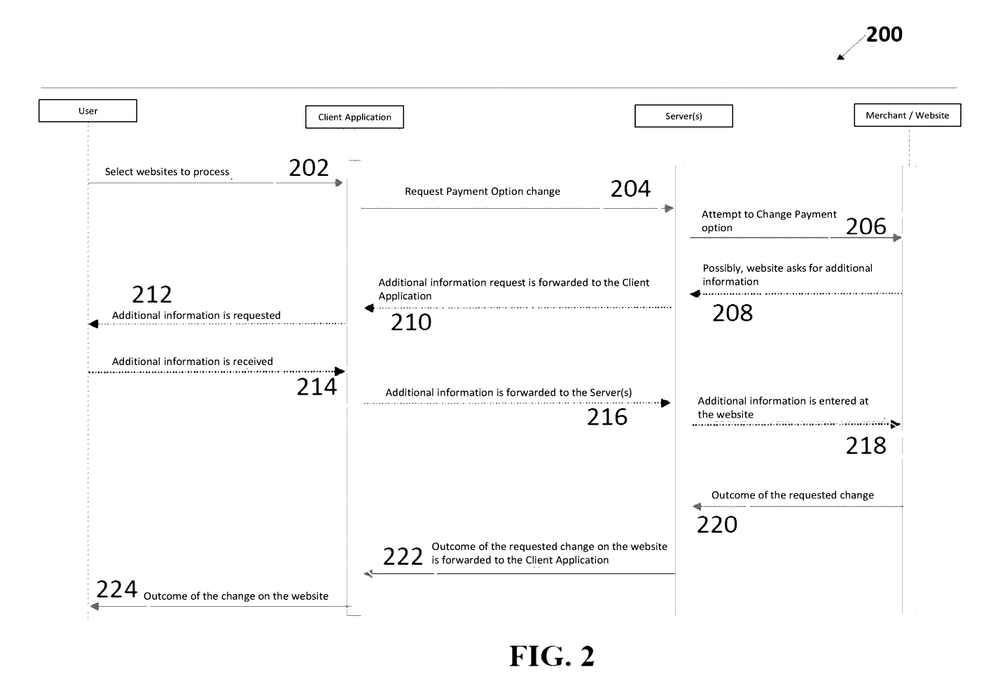

FIG. 2 illustrates an exemplary method 200 for managing payment options associated with a user and merchants as described herein. As an example, method 200 may be executed by an exemplary system such as shown in FIGS. 1 and 4. In examples, method 200 may be executed on a device comprising of at least one processor configured to store and execute operations, programs or instructions. However, method 200 is not limited to such examples. In at least one example, method 200 may be executed (e.g., computer-implemented operations) by one or more components of a distributed network, for instance, a web service or distributed network service (e.g. cloud service). In examples, operations performed in method 200 may correspond to operations executed by a system and/or service that execute computer programs, application programming interfaces (APIs), or machine-learning processing, among other examples.

Method 200 begins at operation 202, when a user may select one or more websites to process. For example, in the exemplary system of FIG. 1, the user may access application 104 on processing device 102. The user may login to application 104 using login credentials. Upon logging in to application 104, the user may be able to view the user profile. For example, the user may be able to view a list of credit and/or debit cards on the user's profile. In addition, the user may be able to view a list of merchants associated with each cards. For example, for each cards listed on the user profile, the user may be able to view a list of merchants with whom the card is already known to have been used to make one or more payments. The user may select websites associated with a card to process. For example, the user may select a list of websites where card information associated with a card needs to be updated. Alternatively, the user may directly enter websites to process on application 104. In one embodiment, application 104 may pre-select the websites and the user may confirm the pre-selected websites. The user may confirm by clicking a button in the user interface of application 104.

After selection of the websites at operation 202, method 200 may proceed to operation 204, where the application asks for a change to a payment option to be made. Although portions of the present disclosure may be described in relation to a credit card or other card-based payment option, the methods and systems disclosed herein may be used with any payment option. In the exemplary system of FIG. 1, application 104 may contact server 108 to update the card information with the selected websites. Application 104 may contact server 108 over network 106 via a private encrypted message. The message from Application 104 may include merchant details, website domains, user credentials for logging on the websites, and updated card information.

Method 200 may then proceed to operation 206, where the server updates (or attempts to update) the card information at the merchant website(s). In the exemplary system of FIG. 1, server 108 may update card information with the merchant and/or websites. For example, after receiving the merchant details, the website domains, the user credentials for websites, and the updated card information, server 108 may create one or more scripts to be run on the selected websites. In examples, a script may be a set of instructions that allows navigation on a given website (for example using a headless browser such as PhantomJS) and performance of various actions (clicking on links or buttons, filling forms, etc.) on the website. The script may contain a logic that allows changing card information registered on a website. The script may be specific for each merchant and website. For example, server 108 may create one script for each website to be updated. Server 108 may create scripts based on the received information to be executed on the selected websites. Server 108 may execute scripts to login and/or update the card information on the selected websites.

At operation 208 of method 200, upon execution of the scripts, the websites may need additional information to update the card information. For example, the websites may require a security token from the user. In the exemplary system of FIG. 1, the additional information required by the websites may be requested from server 108.

After receiving request for additional information at operation 208, method 200 may proceed to operation 210, where the server may forward the received request to the application. In the exemplary embodiment of FIG. 1, server 108 may forward the received request to application 104. For example, server 108 may send a private encrypted message over communication channel 106 seeking the additional information.

Method 200 may proceed to operation 212 where the application may request the required additional information from the user. For example, application 104 may prompt the user for the additional information through the user interface displayed on device 102. In response to the prompt, the user, at operation 214 of method 200, may provide the additional information to application 104 through the user interface of processing device 102.

Method 200 may proceed to operation 216, where the additional information provided by the user may be forwarded to the server. For example, application 104 may create a private encrypted message to include the additional information received from the user. Application may send the private message to server 108 over communication medium 106.

Method 200 may proceed to operation 218, where the server may provide the additional information to the web site(s). For example, server 108 may provide the additional information to the web servers 110. For example, server 108 may receive the additional information from application 104, and fill the additional information on the interfaces of websites hosted by web servers 110. If needed, server 108 may create scripts to be executed on the websites to fill the additional information.

At operation 220 of method 200, an outcome of the change on the selected websites may be determined. For example, the script for updating the card information, may determine an outcome of execution of the script. The outcome may include “update successful,” “update failed,” and “update requires additional information.” In the exemplary system of FIG. 1, the script may inform server 108 of the outcome of the change. If the outcome of the change is “additional information required,” method 200 may proceed to operation 208. If the outcome of the change is “update successful” or “update failed,” method 200 may proceed to operation 222.

At operation 222 of method 200, the outcome of the change on the website may be forwarded to the application, such as client application 104. For example, server 108 may forward the outcome to application 104 over by sending a private message over communication medium 106.

Method 200 may proceed to operation 224, where the user may be notified of the outcome. For example, application 104 may display the outcome on the user interface associated with the user on processing device 102.

In one embodiment, operations 208, 210, 212, 214, 216, and 218 are optional operations of method 200. For example, operations 208, 210, 212, 214, 216, and 218 may not be performed on websites that do not need additional information to update the card information. In another embodiment, operation 212 and operation 214 may not always be performed. For example, the additional information requested by the websites may be stored and available to application 104. In such examples, application 104 may not prompt user to provide the additional information.

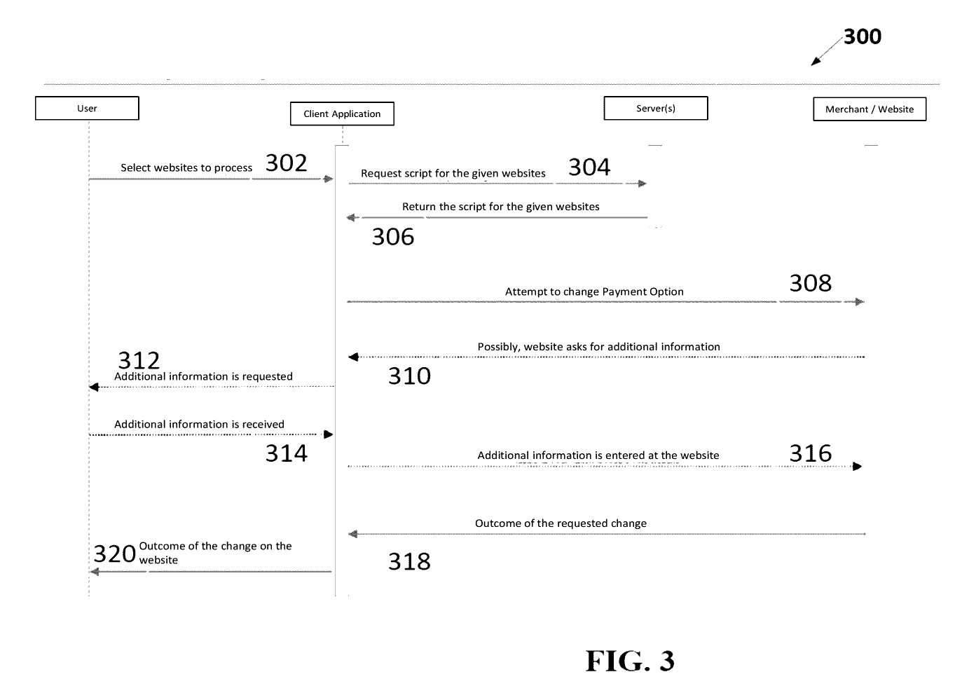

FIG. 3 illustrates another exemplary method 300 for managing payment options associated with the user as described herein. For example, method 300 illustrates method 300 when one or more scripts updating card information are executed by the application. Method 300 may be executed by an exemplary system such as shown in FIG. 1 and FIG. 4. In examples, method 300 may be executed on a device comprising at least one processor configured to store and execute operations, programs or instructions. However, method 300 is not limited to such examples. In at least one example, method 300 may be executed (e.g., computer-implemented operations) by one or more components of a distributed network, for instance, web service or distributed network service (e.g. cloud service). In examples, operations performed in method 300 may correspond to operations executed by a system and/or service that execute computer programs, application programming interfaces (APIs), or machine-learning processing, among other examples.

Method 300 begins at operation 302 where a user may select one or more websites to process. For example, the user may access application 104 on processing device 102. The user may login to application 104 using login credentials. Upon login in application 104, the user may be able to view a user profile. For example, the user may be able to view a list of credit and/or debit cards on the user's profile. In addition, the user may be able to view a list of merchants. For example, for each card listed on the user profile, the user may be able to see a list of corresponding merchant details (e.g., the merchant's website) where the information associated with the card is saved for making a payment. The user, while using application 104, may be able to select one or more of merchants or websites to process. In addition, the user, through application 104, may enter a name of a merchant and/or website for a card. For example, the user may enter the name of a merchant and/or a website on which the information associated with a card needs to be updated.

After selection of the website at operation 302, method 300 may proceed to operation 304. Referring to the exemplary embodiment of FIG. 1, application 104 may contact server 108 for a script. For example, application 104 may create a private encrypted message requesting server 108 to create scripts for changing card information associated with a client at the selected website. The private message may include merchant details, website domains, user credentials for websites, and updated card information. Application 104 may send the private message to server 108 over network 106.

At operation 306 of method 300, the server may return the script. In the exemplary embodiment of FIG. 1, server 108 may return at least one script to application 104. For example, after receiving the request for a script, server 108 may generate a script for each of the cards and websites selected by the user. The created scripts may be returned to application 104 by server 108 over network 108. The scripts may be returned in an encrypted message.

At operation 308 of method 300, the application may navigate the websites selected by the user using the scripts. In the exemplary embodiment of FIG. 1, the scripts 104 may be used to navigate on the websites by executing the scripts received from server 108. Using the received scripts, application 104 may log in on the websites and update the card information associated with the user on the websites.

At operation 310 of method 300, the websites may require additional information to update the card information. For example, the websites may require a security token from the user. In the exemplary embodiment of FIG. 1, the additional information required by the websites may be conveyed to application 104 by the executing scripts. After receiving request for additional information at operation 310, method 300 may proceed to operation 312, where the application, such as application 104, may request the additional information from the user. For example, application 104 may prompt the user to enter the additional information. In response to the prompt, the user, at operation 314 of method 300, may provide the additional information to application 104. For example, the user may provide the additional information to application 104 using a user interface operating on processing device 102.

At operation 314 of method 300, the additional information provided by the user may be filled on the websites. For example, application 104 may receive the additional information from application 104, and fill the additional information on the websites. If needed, server 108 may create new scripts to be executed on the websites to fill the additional information.

At operation 318 of method 300, the outcome of the change on the websites may be determined. For example, the script for updating the card information may determine an outcome of execution of the script. The outcome may include “update successful,” “update failed,” and “update requires additional information.” The script may inform application 104 of the outcome of the change. If the outcome of the change is “additional information required,” method 300 may proceed to operation 310. If the outcome of the change is “update successful” or “update failed,” method 300 may proceed to operation 320.

At operation 320 of method 300, the user may be notified of the outcome of the change on the website. For example, application 104 may display the outcome on the user interface associated with the user on processing device 102.

In one embodiment, operations 310, 312, 314, and 318 are optional operations of method 300. For example, operations 310, 312, 314, and 318 may not be performed on the website which does not need additional information to update the card information. In another embodiment, operation 312 and operation 314 may not always be performed. For example, the additional information requested by the websites may be present at and provided by application 104. In such examples, application may not prompt user to provide the additional information.

FIG. 4 illustrates a flow diagram of yet another exemplary method 400 for managing payment options. For example, method 400 illustrates a method for one or more scripts to update card information. Method 400 may be executed by an exemplary system such as shown in FIG. 1. In examples, method 400 may be executed on a device comprising at least one processor configured to store and execute operations, programs or instructions. However, method 400 is not limited to such examples. In at least one example, method 400 may be executed (e.g., computer-implemented operations) by one or more components of a distributed network, for instance, web service or distributed network service (e.g. cloud service). In examples, operations performed in method 400 may correspond to operations executed by a system and/or service that execute computer programs, application programming interfaces (APIs), or machine-learning processing, among other examples.

Method 400 begins at operation 402, where the application may receive a trigger to change payment option information. For example, application 104 may receive a trigger to change information associated with a credit card of a user. The trigger may be received in response to either change in the information associated with the payment option or initiated by the user to change the information associated with the payment option.

After receiving the trigger at operation 402, method 400 may then proceed to operation 404, where the application may retrieve a list of websites and merchants associated with the payment option. For example, application 104 may retrieve a list of websites and merchant addresses where the payment option information has been saved and needs to be updated. The list may be obtained from a local repository associated with application 104 or may be manually entered by the user.

Once the list of websites and the merchants is retrieved at operation 404, method 400 may proceed to operation 406, where the application may access each website and merchants on the list in a sequence. For example, application 104 may access the first website/merchant listed on the retrieved list. Accessing the website may include connecting to a server hosting the website or storing payment option information.

At operation 408 of method 400, the application may try to auto-login into the first website/merchant listed on the retrieved list. For example, application 104 may create and run an auto-login script on a server associated with server hosting the first website/merchant listed on the retrieved list. At operation 410, the application determines if the login was successful. If the script successfully auto-logins on the first website/merchant, application 104 may proceed to operation 418. If the script fails to auto-login on the first website/merchant at operation 410, method 400 may proceed to operation 412 where the application may run a fallback script to auto-login. When the fallback script fails to auto-login on the first website/merchant at operation 414, method 400 may proceed to operation 416, where the application may prompt the user for user input to login on the first website/merchant and uses the received information to login.

Once the application (such as application 104) successfully logs in to the first website/merchant, method 400 may proceed to operation 418 where the application may try to update the payment option information on the first website/merchant. When the application (such as application 104) fails to update the payment option information at operation 420, method 400 may proceed to operation 422 where the application (such as application 104) may run another fallback script to update the payment option information. If the application succeeds in updating the payment option, then flow proceeds to operation 428. If the application (such as application 104) fails to update the payment option information using the fallback script at operation 424, the application may, at operation 426, prompt the user for information and use that information to change the payment option information at the first website/merchant. If the card information is successfully updated at operation 420 or following operations 424 or 426, the application at operation 428 may present result of the payment option information update to the user for review.

In one example embodiment, operations 406 to operations 428 may be repeated by the application (such as application 104) for each of the websites/merchants listed for the first payment option. In addition, operations 406 to operations 428 may be repeated by the application 104 (such as application 104) for each of the payment options associated with the user. Moreover, method 400 may first run a semantic engine to auto-login before changing payment option information at the merchants/websites. In case of a failure, method 400 may fall back on scripts triggered either server-side or client-side. For example, in case of failure, method 400 may default to prompting the user for input whenever necessary.

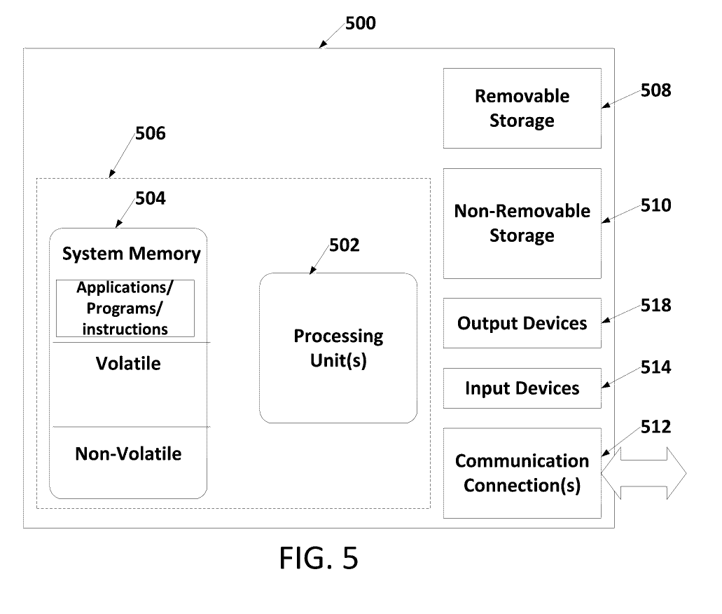

FIG. 5 and the additional discussion in the present specification are intended to provide a brief general description of a suitable computing environment in which the present disclosure and/or portions thereof may be implemented. Although not required, the embodiments described herein may be implemented as computer-executable instructions, such as by program modules, being executed by a computer, such as a client workstation or a server. Generally, program modules include routines, programs, objects, components, data structures and the like that perform particular tasks or implement particular abstract data types. Moreover, it should be appreciated that the invention and/or portions thereof may be practiced with other computer system configurations, including hand-held devices, multi-processor systems, microprocessor-based or programmable consumer electronics, network PCs, minicomputers, mainframe computers and the like. The invention may also be practiced in distributed computing environments where tasks are performed by remote processing devices that are linked through a communications network. In a distributed computing environment, program modules may be located in both local and remote memory storage devices.

FIG. 5 illustrates one example of a suitable operating environment 500 in which one or more of the present embodiments may be implemented. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like.

In its most basic configuration, operating environment 500 typically may include at least one processing unit 502 and memory 504. Depending on the exact configuration and type of computing device, memory 504 (storing, among other things, venue-based applications module(s), e.g., venue check-in applications, venue search applications, geocoding/reverse geocoding applications, APIs, programs, etc. and/or other components or instructions to implement or perform the system and methods disclosed herein, etc.) may be volatile (such as RAM), non-volatile (such as ROM, flash memory, etc.), or some combination of the two. This most basic configuration is illustrated in FIG. 5 by dashed line 506. Further, environment 500 may also include storage devices (removable, 508, and/or non-removable, 510) including, but not limited to, magnetic or optical disks or tape. Similarly, environment 500 may also have input device(s) 514 such as a keyboard, mouse, pen, voice input, etc. and/or output device(s) 516 such as a display, speakers, printer, etc. Also included in the environment may be one or more communication connections, 512, such as LAN, WAN, point to point, etc.

Operating environment 500 may include at least some form of computer readable media. The computer readable media may be any available media that can be accessed by processing unit 502 or other devices comprising the operating environment. For example, the computer readable media may include computer storage media and communication media. The computer storage media may include volatile and nonvolatile, removable and non-removable media implemented in any method or technology for storage of information such as computer readable instructions, data structures, program modules or other data. The computer storage media may include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information. The computer storage media does not include communication media or any propagated data signal or other carrier wave.

The communication media may embody computer readable instructions, data structures, program modules, or other data in a modulated data signal such as a carrier wave or other transport mechanism and includes any information delivery media. The term “modulated data signal” may mean a signal that has one or more of its characteristics set or changed in such a manner as to encode information in the signal. For example, the communication media may include a wired media such as a wired network or direct-wired connection, and wireless media such as acoustic, RF, infrared and other wireless media. Combinations of the any of the above should also be included within the scope of computer readable media.

The operating environment 500 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

The different aspects described herein may be employed using software, hardware, or a combination of software and hardware to implement and perform the systems and methods disclosed herein. Although specific devices have been recited throughout the disclosure as performing specific functions, one skilled in the art will appreciate that these devices are provided for illustrative purposes, and other devices may be employed to perform the functionality disclosed herein without departing from the scope of the disclosure.

As stated above, a number of program modules and data files may be stored in the system memory 504. While executing on the processing unit 502, program modules 508 (e.g., applications, Input/Output (I/O) management, and other utilities) may perform processes including, but not limited to, one or more of the stages of the operational methods described herein such as method 200, method 300, and method 400 illustrated in FIG. 2, FIG. 3, and FIG. 4 for example.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the operating environment 500 on the single integrated circuit (chip). Examples of the present disclosure may also be practiced using other technologies capable of performing logical operations such as, for example, AND, OR, and NOT, including but not limited to mechanical, optical, fluidic, and quantum technologies. In addition, examples of the invention may be practiced within a general purpose computer or in any other circuits or systems.

This disclosure described some aspects of the present technology with reference to the accompanying drawings, in which only some of the possible embodiments were shown. Other aspects may, however, be embodied in many different forms and should not be construed as limited to the embodiments set forth herein. Rather, these aspects were provided so that this disclosure was thorough and complete and fully conveyed the scope of the possible embodiments to those skilled in the art.

Although specific aspects were described herein, the scope of the technology is not limited to those specific embodiments. One skilled in the art will recognize other embodiments or improvements that are within the scope and spirit of the present technology. Therefore, the specific structure, acts, or media are disclosed only as illustrative embodiments. The scope of the technology is defined by the following claims and any equivalents therein.

What is claimed is:

1. A computer-implemented method comprising:
receiving a trigger for updating user information associated with a payment option, the trigger comprising a change in the user information associated with the payment option;
determining at least one website associated with the payment option;
providing a script to be run on the determined at least one website to update the user information; and
causing the script to be executed on the at least one website to update the user information.

2. The computer implemented method of claim 1, further comprising:
determining whether the user information is successfully updated on the at least one website;
providing, in response to the user information not being successfully updated, a fallback script; and
causing the fallback script to be executed on the at least one website.

3. The computer implemented method of claim 1, further comprising:
determining whether the user information is successfully updated on the at least one website;
prompting, in response to the user information not being successfully updated, a user to enter login credentials for the at least one website;
logging on the at least one website using the entered login credentials; and
updating the user information on the at least one website.

4. The computer implemented method of claim 1, wherein providing the script to be run on the at least one website comprises generating the script on a user device.

5. The computer implemented method of claim 1, wherein causing the script to be executed on the at least one website comprises sending the script to a server associated with the at least one website.

6. The computer implemented method of claim 1, wherein prompting the user to enter login credentials comprises providing a user interface to enter the login credentials on a user device.

7. The computer implemented method of claim 1, wherein receiving the trigger for updating the user information comprises receiving the trigger from a user to update the user information on a specific website.

8. The computer implemented method of claim 1, wherein receiving the trigger for updating user information comprises receiving the trigger from a financial institution associated with the payment option.

9. The computer implemented method of claim 1, wherein receiving the trigger to update user information comprises receiving the trigger in response to breach information from at least one of the following: a merchant, a merchant website, a bank, a bank website, and a third-party breach alert provider.

10. The computer implemented method of claim 1, wherein the update of the user information on the at least one website comprises submitting user information based on semantic analysis of the at least one website.

11. The computer implemented method of claim 1, further comprising providing an error message comprising results of the update of user information.

12. The computer implemented method of claim 1, wherein providing the script comprises causing a second server to generate the script for the at least one website.

13. A system comprising:
one or more processors; and
a memory coupled to the one or more processors, the memory for storing instructions which, when executed by the one or more processors, performs a method for managing payment options, the method comprising:
receiving a trigger for updating user information associated with a payment option, the trigger comprising a change in the context of user information associated with the payment option;
determining at least one website associated with the payment option;
providing a script to update the user information on the at least one website; and
causing the script to be executed to update the user information.

14. The system of claim 13, wherein the script when executed on the server deletes previously saved user information and adds updated user information associated with the payment option.

15. The system of claim 13, wherein the script is executed at least partially at a user device associated with a user.

16. The system of claim 15, wherein the user device is a cellular device.

17. The system of claim 15, wherein the user device is a personal computing device.

18. The system of claim 15, wherein the user device is configured to store a list of websites associated with a plurality of payment options used by a user.

19. A computer-readable storage medium encoding computer executable instructions which, when executed by one or more processors, performs a method of managing payment options, the method comprising:
receiving a trigger for updating user information associated with a payment option, the trigger comprising a change in the user information associated with the payment option;
determining at least one website associated with the payment option;
providing a script to be run on the determined at least one website to update the user information; and
causing the script to be executed on the at least one website to update the user information.

20. The computer-readable storage medium of claim 19, wherein the payment option is at least one of the following: a credit card, a debit card, a checking account, a saving account, a travel card, and a pre-paid card.
